(19) United States
(12) Patent Application Publication
(10) Pub. No.: US 2017/0371165 A1
(43) Pub. Date: Dec. 28, 2017

(54) HEAD UP DISPLAY WITH STABILIZED VERTICAL ALIGNMENT

(71) Applicant: Panasonic Automotive Systems Company of America, Division of Panasonic Corporation of North America, PEACHTREE CITY, GA (US)

(72) Inventor: DAVID KAY LAMBERT, STERLING HEIGHTS, MI (US)

(73) Assignee: Panasonic Automotive Systems Company of America, Division of Panasonic Corporation of North America

(21) Appl. No.: 15/623,918

(22) Filed: Jun. 15, 2017

Related U.S. Application Data
(60) Provisional application No. 62/353,528, filed on Jun. 22, 2016.

(51) Int. Cl. G02B 27/01

(52) U.S. Cl. CPC G02B 27/0179; G02B 27/0149; G02B 27/0101; G02B 2027/0159; G02B 2027/0181; G02B 2027/014

(57) ABSTRACT

A head up display arrangement for a motor vehicle includes an image source emitting a virtual image based on image data. A mirror is positioned to reflect the virtual image such that the virtual image further reflects off of a windshield of the motor vehicle and is visible to a driver of the vehicle while eyes of the driver are disposed within an eyebox. A driver's input device is coupled to the mirror and changes an angle of reflection of the mirror and thereby changes a vertical level of the eyebox in response to input from the driver. A controller is communicatively coupled to the image source and produces the image data. The controller determines the angle of reflection of the mirror, and adjusts the image data in response to the change in the angle of reflection of the mirror such that a vertical level of the virtual image is unchanged by the change in the angle of reflection of the mirror.

### CROSS-REFERENCED TO RELATED APPLICATIONS

This application claims benefit of U.S. Provisional Application No. 62/353,528 filed on Jun. 22, 2016, which the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

A head up display emits light that reflects from the front windshield to be seen by the driver. The light appears to come from a virtual image in front of the driver and in front of the windshield.

Conventional head up displays create the virtual image by first using a display to create an image. Next, the light from the image is reflected from one or more mirrors. Next, the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

### SUMMARY

The present invention may provide a head up display wherein the perceived vertical alignment of the displayed graphics is kept constant, independent of adjustment of the HUD eye box position for the height of the driver. The adjustment of the HUD for vertical height may involve changing the rotational angle of a mirror. Either the angle of the mirror can be measured, or software can keep track of the current position of the mirror. In some HUDs, the mirror is placed in a “park” position each time the vehicle is turned off. Alternatively, instead of actually measuring the rotational angle of the mirror, the commanded angle can be determined. Given the current position (or commanded position) of the mirror, the software that places the graphical images on the display internal to the HUD can compensate for any dependence of perceived vertical height of graphics on the vertical position of the eye box.

In one embodiment, the invention comprises a head up display arrangement for a motor vehicle, including an image source emitting a light field based on image data. A mirror is positioned to reflect the light field such that the light field further reflects off of a windshield of the motor vehicle and is visible to a driver of the vehicle as a virtual image while eyes of the driver are disposed within an eyebox. A driver's input device is coupled to the mirror and changes an angle of reflection of the mirror and thereby changes a vertical level of the eyebox in response to input from the driver. A controller is communicatively coupled to the image source and produces the image data. The controller determines the angle of reflection of the mirror, and adjusts the image data in response to the change in the angle of reflection of the mirror such that a vertical level of the virtual image is unchanged by the change in the angle of reflection of the mirror.

In another embodiment, the invention comprises a head up display method for a motor vehicle, including emitting a light field based on image data. The light field is reflected with a mirror such that the light field further reflects off of a windshield of the motor vehicle and is visible to a driver of the vehicle as a virtual image while eyes of the driver are disposed within an eyebox. An angle of reflection of the mirror is changed, thereby changing a vertical level of the eyebox, in response to input from the driver. The angle of reflection of the mirror is determined. The image data is adjusted in response to the change in the angle of reflection of the mirror such that a vertical level of the virtual image is unchanged by the change in the angle of reflection of the mirror.

In yet another embodiment, the invention comprises a head up display method for a motor vehicle, including emitting a light field based on image data. The light field is reflected off of a windshield of the motor vehicle such that the light field is visible to a driver of the vehicle as a virtual image while eyes of the driver are disposed within an eyebox. A trajectory of the light field is changed to thereby change a vertical level of the eyebox, in response to input from the driver. The image data is changed in response to the change in the trajectory of the light field such that a vertical level of the virtual image is unchanged by the change in the trajectory of the light field.

An advantage of the present invention is that it may correct the vertical position of the HUD virtual image after the vertical position of the eyebox has been adjusted.

### BRIEF DESCRIPTION OF THE DRAWINGS

A better understanding of the present invention will be had upon reference to the following description in conjunction with the accompanying drawings.

FIG. 1 is a schematic diagram of one example embodiment of a HUD arrangement of the present invention.

FIG. 2 is a schematic diagram of an example of adjustment of the virtual image in response to a change in the vertical level of the eyebox.

FIG. 3 is a flow chart of one example embodiment of a head up display method of the present invention for a motor vehicle.

### DETAILED DESCRIPTION OF THE PREFERRED EMBODIMENTS

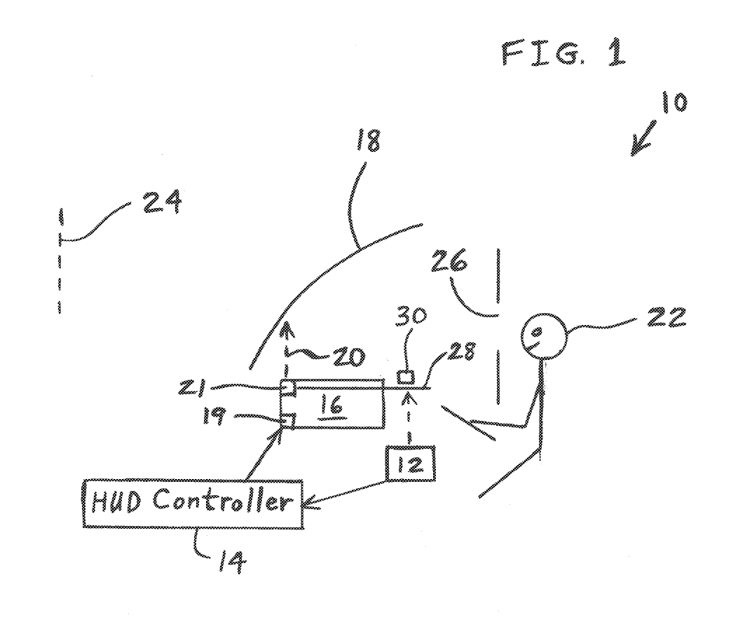

FIG. 1 illustrates one embodiment of a HUD arrangement 10 of the present invention, including a driver's input device 12, a HUD controller 14, HUD hardware 16, and a windshield 18. HUD hardware 16 may include a light emitter 19 and at least one mirror 21. Input device 12 may be coupled to mirror 21 such that input device 12 may change the orientation of mirror 21. During use, light emitter 19 of hardware 16 emits a light field 20 that is reflected by mirror 21, and that is further reflected by windshield 18 toward a driver 22. The light field is visible to driver 22 as a virtual image 24 outside of windshield 18. The trajectory of light field 20 defines the location of an eyebox 26, which is the set of boundaries of the area in which the driver's eyes must be for virtual image 24 to be visible.

In order to move the vertical position of eyebox 26 into alignment with the vertical position of the driver's eyes, which may depend upon his stature, the driver may adjust input device 12. However, the vertical movement of eyebox 26 may also change the vertical position of virtual image 24, which may not be desirable if virtual image 24 then obscures the driver's view of the road in front of him, or draws his attention away from the road. That is, adjustment of the head up display for the height of the driver (e.g., by rotating a mirror) may undesirably change the perceived vertical height of graphics relative to the vehicle in front.

According to the invention, arrangement 10 may compensate for the commanded vertical position of graphics displayed on virtual image 24, and for the perceived change in the vertical position of virtual image 24, caused by the vertical adjustment of eye box 26 to compensate for driver height. The vertical adjustment of eye box 26 may be achieved by rotating a mirror 21 within hardware 16. In order to determine the rotational position of the mirror after the driver's adjustment, the rotational position of a shaft 28 that carries the mirror may be determined by a shaft position sensor 30. Although shaft 28 is shown in a particular horizontal orientation in FIG. 1 for ease of illustration, it is to be understood that shaft 28 may be at any orientation relative to the other components of FIG. 1. In one embodiment, shaft 28 is oriented in alignment with a horizontal direction into the page of FIG. 1, and extends in lateral directions to the right and left of the vehicle and driver 22.

There are several possible ways to measure the angle of the shaft relative to a fixed reference, and thus shaft position sensor 30 may be of many different possible types. These include resistive, capacitive, inductive, magnetic, and optical types of shaft position sensors. In principle, any one of these may be used within the scope of the invention to determine the position of the shaft, and hence, the position of the mirror.

The mirror adjustment in the HUD to compensate for driver's height, changes the apparent height of the HUD virtual image above the road. The HUD can determine the setting of the mirror angle that adjusts for the driver's height. Software may be used to compensate in the image data for any change in the apparent height of the HUD virtual image above the road.

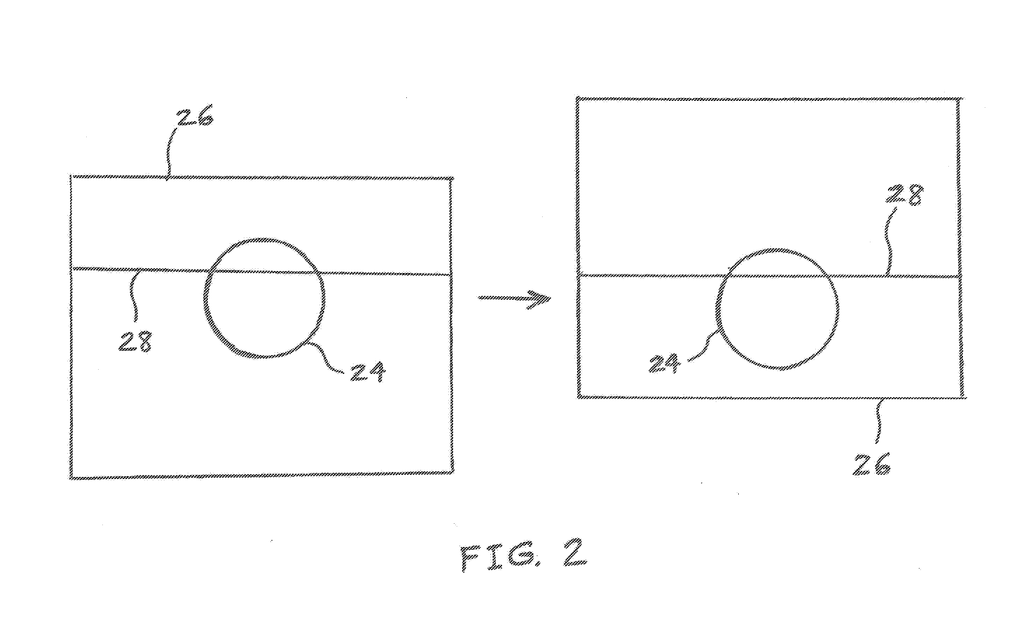

FIG. 2 illustrates an example of adjustment of virtual image 24 in response to a change in the vertical level of eyebox 26. The left half of the drawing shows the position of virtual image 24 and the horizon 28 within eyebox 26. Virtual image 24 is shown as a circle for clarity of illustration, but may more typically be one or more alphanumeric characters. The right half of the drawing shows eyebox 26 after the driver has adjusted its vertical position, and virtual image 24 after software within HUD controller 14 has adjusted the position of virtual image 24 within eyebox 26 to compensate for the vertical adjustment of eyebox 26. As can be seen from a comparison of the left and right sides of FIG. 2, the vertical level of virtual image 24 relative to horizon 28 is unchanged despite the position of eyebox 26 being changed with respect to horizon 28.

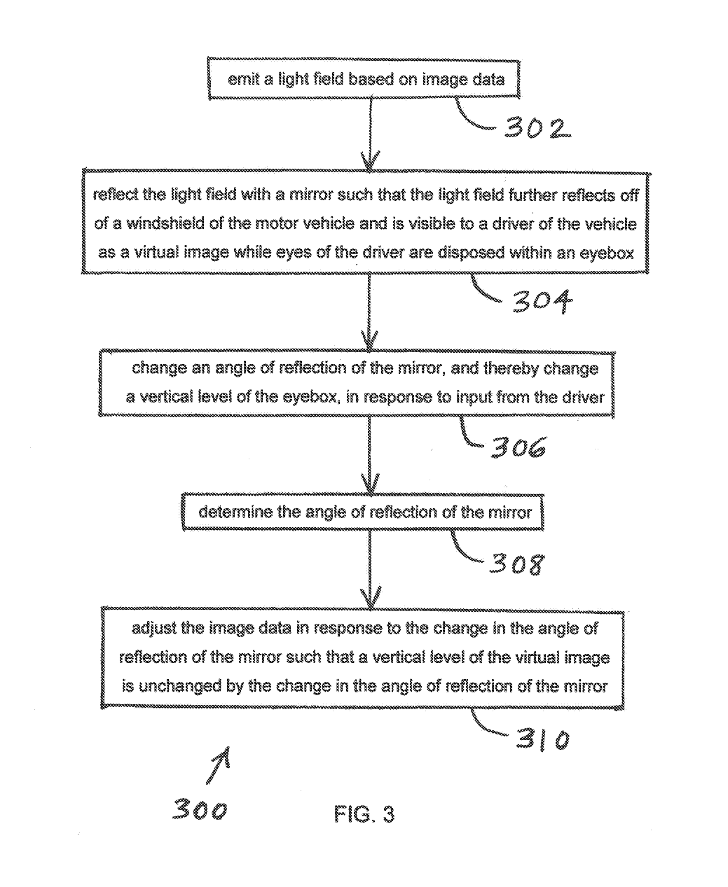

FIG. 3 illustrates one example embodiment of a head up display method 300 of the present invention for a motor vehicle. In a first step 302, a light field is emitted based on image data. For example, light emitter 19 of hardware 16 may emit a light field 20 based upon image data received from HUD controller 14.

Next, in step 304, the light field is reflected by a mirror such that the light field further reflects off of a windshield of the motor vehicle and is visible to a driver of the vehicle as a virtual image while eyes of the driver are disposed within an eyebox. For example, light field 20 may be reflected by mirror 21 such that light field 20 further reflects off of windshield 18 of the motor vehicle and is visible to driver 22 of the vehicle as a virtual image 24 while eyes of driver 22 are disposed within an eyebox 26.

In a next step 306, an angle of reflection of the mirror is changed, thereby changing a vertical level of the eyebox, in response to input from the driver. For example, driver 22 may use input device 12 to change an orientation of mirror 21, thereby changing the trajectory of light field 20, and thereby changing a vertical level of eyebox 26, as shown in FIG. 2.

In step 308, the angle of reflection of the mirror is determined. For example, the rotational position of the shaft that carries mirror 21 may be determined by resistive, capacitive, inductive, magnetic, and/or optical methods.

In a final step 310, the image data is adjusted in response to the change in the angle of reflection of the mirror such that a vertical level of the virtual image is unchanged by the change in the angle of reflection of the mirror. For example, as shown in FIG. 2, the image data from HUD controller 14 may be changed in response to the determined angle of reflection of the mirror such that a vertical level of virtual image 24 is unchanged by the rotation of mirror 21. By adjusting the image data, the contents of virtual image 24, such as the circle shown in FIG. 2, may be moved within eyebox 26 such that the vertical level of the contents of virtual image 24 are unchanged even though the vertical level of eyebox 26 has changed.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display arrangement for a motor vehicle, the arrangement comprising:
an image source configured to emit a light field based on image data;
a mirror positioned to reflect the light field such that the light field further reflects off of a windshield of the motor vehicle and is visible to a driver of the vehicle as a virtual image While eyes of the driver are disposed within an eyebox;
a driver's input device coupled to the mirror and configured to change an angle of reflection of the mirror and thereby change a vertical level of the eyebox in response to input from the driver; and
a controller communicatively coupled to the image source and configured to:
produce the image data;
determine the angle of reflection of the mirror; and
adjust the image data in response to the change in the angle of reflection of the mirror such that a vertical level of the virtual image is unchanged by the change in the angle of reflection of the mirror.

2. The head up display arrangement of claim 1 wherein the image source comprises a projector.

3. The head up display arrangement of claim 2 wherein the projector comprises a display screen.

4. The head up display arrangement of claim 1 wherein the virtual image appears to the driver to be disposed outside the windshield and visible through the windshield.

5. The head up display arrangement of claim 4 wherein the virtual image is approximately between six and eight meters from the driver.

6. The head up display arrangement of claim 1 further comprising:
a rotatable shaft attached to the mirror; and
a shall position sensor configured to sense a rotational position of the shaft, the controller being communicatively coupled to the shaft position sensor.

7. The head up display arrangement of claim 6 wherein the shaft position sensor is resistive, capacitive, inductive, magnetic, or optical.

8. A head up display method for a motor vehicle, the method comprising:
emitting a light field based on image data;
reflecting the light field with a mirror such that the light field further reflects off of a windshield of the motor vehicle and is visible to a driver of the vehicle as a virtual image while eyes of the driver are disposed within an eyebox;
changing an angle of reflection of the mirror, and thereby change a vertical level of the eyebox, in response to input from the driver;
determining the angle of reflection of the mirror; and
adjusting the image data in response to the change in the angle of reflection of the mirror such that a vertical level of the virtual image is unchanged by the change in the angle of reflection of the mirror.

9. The head up display method of claim 8 wherein the light field is emitted by a projector.

10. The head up display method of claim 9 wherein the projector comprises a display screen.

11. The head up display method of claim 8 Wherein the virtual image appears to the driver to be disposed outside the windshield and visible through the windshield.

12. The head up display method of claim 11 wherein the virtual image is approximately between six and eight meters from the driver.

13. The head up display method of claim 8 further comprising:
attaching a rotatable shaft to the mirror; and
sensing a rotational position of the shaft, the adjusting step being dependent upon the sensing.

14. The head up display method of claim 13 wherein the sensing is performed by a shaft position sensor, the shaft position sensor being resistive, capacitive, inductive, magnetic, or optical.

15. A head up display method for a motor vehicle, the method comprising:
emitting a light field based on image data;
reflecting the light field off of a windshield of the motor vehicle such that the light field is visible to a driver of the vehicle as a virtual image while eyes of the driver are disposed within an eyebox;
changing a trajectory of the light field to thereby change a vertical level of the eyebox, in response to input from the driver; and
adjusting the image data in response to the change in the trajectory of the light field such that a vertical level of the virtual image is unchanged by the change in the trajectory of the light field.

16. The head up display method of claim 15 further comprising reflecting the light field with a reflective device such that the light field further reflects off of the windshield.

17. The head up display method of claim 16 wherein the step of changing a trajectory of the light field includes changing an angle of reflection of the reflective device.

18. The head up display method of claim 17 wherein the adjusting step is in response to a sensed change in the angle of reflection of the reflective device.

19. The head up display method of claim 18 further comprising:
attaching a rotatable shaft to the reflective device; and
sensing a rotational position of the shaft, the adjusting step being dependent upon the sensing.

20. The head up display method of claim 19 wherein the sensing is performed by a shaft position sensor, the shaft position sensor being resistive, capacitive, inductive, magnetic, or optical.
